(19) United States
(12) Patent Application Publication
(10) Pub. No.: US 2008/0119125 A1
(43) Pub. Date: May 22, 2008

(54) Ventilation System Air Vent For The Passenger Space Of A Vehicle

(75) Inventor: Pierre Guerreiro, Sannois (FR)

Correspondence Address: YOUNG & THOMPSON, 209 Madison Street, Suite 500, ALEXANDRIA, VA, 22314, US

(73) Assignee: FAURECIA INTERIEUR INDUSTRIE, NANTERRE (FR)

(21) Appl. No.: 11/666,727

(22) PCT Filed: Oct. 27, 2005
(86) PCT No.: PCT/FR05/02701

§ 371 Date: May 2, 2007

(30) Foreign Application Priority Data
Nov. 3, 2004 (FR) 0411729

(51) Int. Cl. B60H 1/00

(52) U.S. Cl. 454/75

(57) ABSTRACT

A ventilator flap, making up the terminal part of a main air duct providing an upstream air flow (3). The ventilator flap is provided with diffusion elements, directing elements, and control elements for going from one mode to the other which includes a central duct (5), at least partly coaxial to an annular duct (8), the two ducts (5, 8) having the upstream ends thereof (2) connected to the principal air duct and each having, at the downstream end thereof, one of the diffusion and directing elements and a control bush (12), which may be displaced between a first position, in which the above serves to close a connection between the central duct (5) and the annular duct (8) and a second position in which the above serves to open the connection.

The invention relates to the automotive industry and more particularly devices for introducing air into the passenger space, which constitute the terminal portion of heating, ventilation and climate-control systems of vehicles.

In the most conventional configurations of heating, ventilation and climate-control systems with which motor vehicles are provided, the air flows introduced into the passenger space are of two types. The flows which are intended to be able to be orientated directly onto the occupants of the vehicle are introduced into the passenger space via fixed or orientable air vents. The flows which are intended for indirect diffusion in the passenger space are introduced therein through gentle diffusion grilles which are completely separate from the air vents. In order to provide the two functions of direct and indirect diffusion, therefore two different classes of diffusion means are used.

In order to simplify the design of the air diffusion installation and reduce the proportion of the surface of the dashboard which is dedicated to this function, it would be desirable to be able to carry out these functions using the same classes of element. A solution of this type has already been proposed in document US-A-2004/0063397 in the form of a air vent which is constituted by a hollow cylinder which has a first directional grille over one half of the surface thereof and a diffusion grille over the other half of the surface thereof. A manual control is provided for the user who can select between direct diffusion and indirect diffusion of the air with no intermediate position. In this construction, the flow of air is subject to right-angled rotation between the upstream flow and the downstream flow, which is unfavourable in terms of ventilation and acoustics. Furthermore, the assembly of the device in the dashboard is complex owing to the presence of a rotation axis which must extend from left to right or from top to bottom relative to the occupants of the vehicle.

The object of the invention is to provide a new type of air vent which can simultaneously provide both functions of direct and indirect diffusion of the ventilation air in the passenger space in a more effective manner than those which are already known.

To this end, the invention relates to a ventilation system air vent for the passenger space of a motor vehicle, which constitutes the terminal portion of a main air duct which conveys an upstream flow of air, the air vent being provided with diffusion means for converting the upstream flow of air into a downstream flow of diffusion air, directional means for converting the upstream flow of air into a downstream flow of directional air and control means for switching from one downstream air flow mode to the other by means of connecting one or other of the diffusion means and directional means to the main air duct, characterised in that it comprises a central duct which is at least partially coaxial relative to an annular duct, the two ducts having their upstream ends connected to the main air duct and each having, at the downstream end thereof, one of the diffusion means and directional means, and a control ring being able to be placed between a first position in which it serves to close a connection between the central duct and the annular duct and a second position in which the ring serves to open this connection.

It may also comprise means for blocking the central duct, which means are controlled by the movement of the ring.

The means for blocking the central duct may be constituted by at least one flap.

In a first variant of the invention, a common cylindrical wall separates the central duct and the annular duct, the common wall is provided with perforations along one of the circumferences thereof, the ring is inserted around the common wall and carries perforations which can, by rotating the ring to at least one angular position, move into alignment with the perforations of the common wall, the ring also being able, by rotating to at least another angular position, to block the perforations of the common wall.

The diffusion means may comprise one or more perforations which are provided, at the end of the annular duct, in the front portion of the ring which is intended to protrude into the passenger space of the vehicle when the air vent is mounted in the dashboard.

In a second variant of the invention, the ring constitutes a common cylindrical wall which separates the central duct and the annular duct, it comprises means which allow translation of the ring along the longitudinal axis thereof simultaneously with the rotation thereof in order to move the ring from a position for blocking the annular duct to a position for blocking the central duct.

The front portion of the ring may comprise, on the periphery thereof, a lip which, when the ring is in a position of maximum retraction, is intended to come into contact with the outer face of the dashboard in order to block the annular duct, when the ring is in an advanced position, the rear end thereof is remote from the outer wall of the air vent in order to allow the passage of at least a portion of the flow of upstream air in the annular duct in order to constitute the flow of diffusion air and, in this same advanced position, the lip is intended to be remote from the dashboard in order to define an annular opening through which the flow of diffusion air can be introduced into the passenger space.

The means which allow a translation of the ring simultaneously with the rotation thereof may comprise one or more helical ribs which are inserted in one or more corresponding housings provided on a component which is fixedly joined to the outer wall of the air vent.

The diffusion means may comprise at least one perforation which is provided on at least a portion of the outer wall of the air vent and via which the downstream flow of diffusion air is introduced into the passenger space.

They may comprise a mouthpiece which directs in the passenger space the downstream flow of diffusion air which is discharged from the perforation.

The ring may preferably be retained in at least one intermediate position between the first and second positions, in order to simultaneously allow the passage of a downstream flow of diffusion air and a downstream flow of directional air in the passenger space.

As it has been understood, the air vent according to the invention comprises two coaxial ducts which are each connected to the main air duct. One carries at the downstream end thereof the means for direct diffusion and the other carries at the downstream end thereof the means for indirect diffusion. A ring which can be controlled by the user allows the user to readily select one or other of the two types of air diffusion via the relevant air vent and preferably various compromises between these two types of diffusion. The air vent according to the invention has a simple design and is therefore inexpensive to produce.

The invention will be better understood from a reading of the following description, given with reference to the appended figures below, in which:

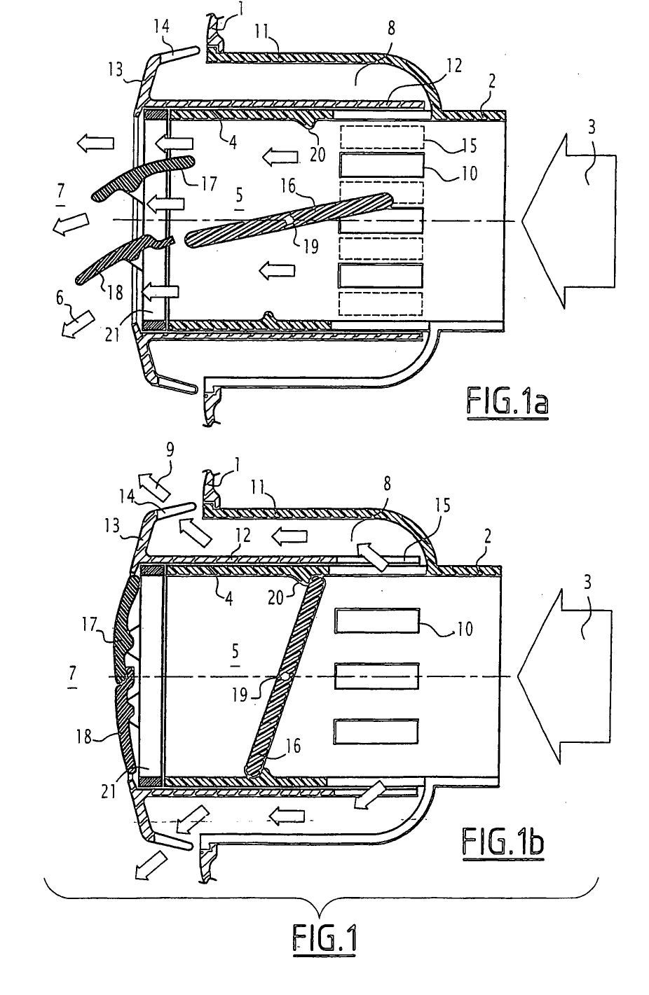

FIG. 1 is a longitudinal section of a first example of an air vent according to the invention, in a position for direct diffusion (FIG. 1a) and in a position for indirect diffusion (FIG. 1b);

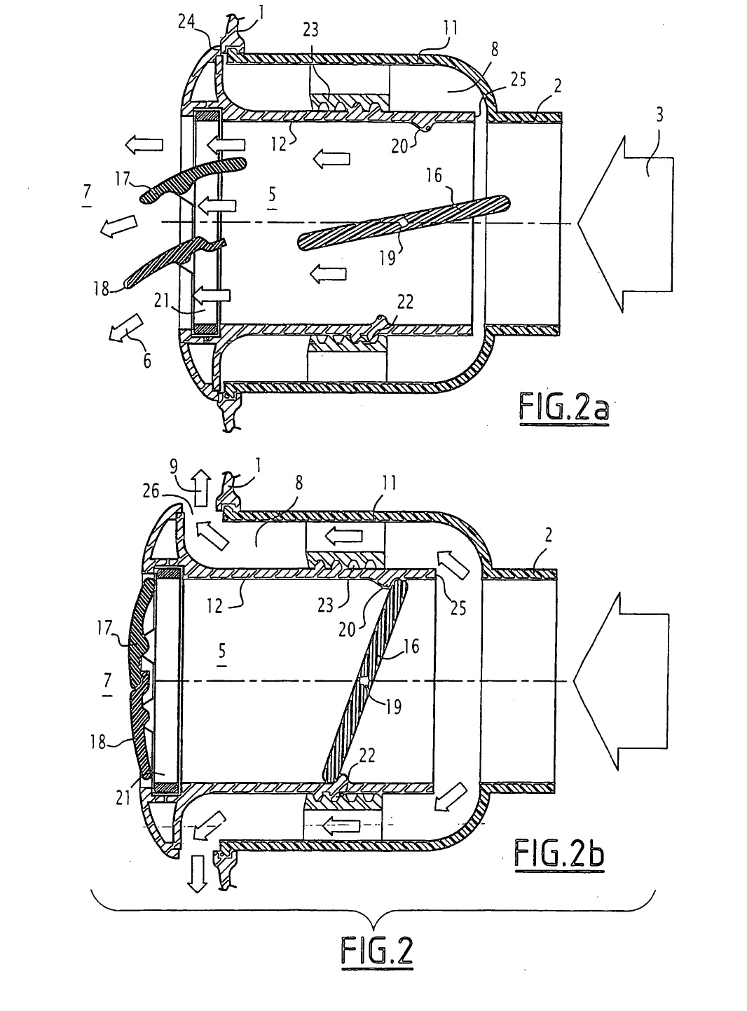

FIG. 2 is a longitudinal section of a second example of an air vent according to the invention, in a position for direct diffusion (FIG. 2a) and in a position for indirect diffusion (FIG. 2b);

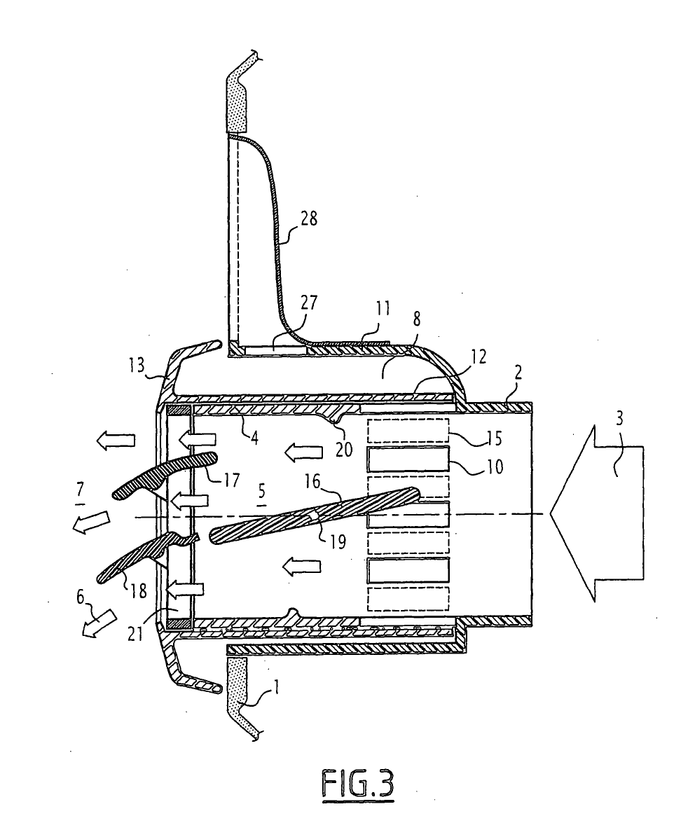

FIG. 3 is a longitudinal section of a third example of an air vent according to the invention, in a position for direct diffusion.

A first example of an air vent according to the invention, illustrated in FIG. 1, is intended to be embedded in a hole which is provided in the dashboard 1 of the vehicle and to be connected, with the upstream end thereof, in a connection zone 2, to a main air duct (not illustrated) which is itself connected to the heating, ventilation and climate-control installation of the vehicle. The main air duct conveys to the air vent an upstream flow of air indicated by the arrow 3.

Downstream of the connection zone 2, the air vent comprises two coaxial ducts which have circular cross-sections which are separated by a common cylindrical wall 4. The central duct 5 is dedicated to the passage of a downstream flow of directional air indicated by the arrows 6, in the passenger space 7 of the vehicle. The annular duct 8 is dedicated to the passage of a downstream flow of diffusion air which is indicated by the arrows 9.

The common wall 4 which separates the two ducts 5, 8 is provided with spaced perforations 10 which are located in the upstream portion thereof and which are arranged along a circumference of the common wall 4.

The annular duct 8 is defined on the one hand by the outer wall 11 of the air vent and, on the other hand, by a cylindrical ring 12 which is inserted around the common wall 4 and which can rotate about the longitudinal axis thereof. The front portion 13 of this ring 12 which protrudes in the passenger space 7 carries a series of perforations 14 which are distributed over the periphery thereof (or a single perforation which extends over the whole or part of this periphery) and via which the downstream flow 9 of diffusion air is introduced into the passenger space, with an orientation which is very substantially divergent relative to the longitudinal axis of the air vent so as not to be directed towards the occupants of the vehicle. The wall of the ring 12 carries spaced perforations 15 which, when the ring 12 is inserted in the air vent, can move into alignment with the perforations 10 of the common wall 4 if the ring 12 is turned by the user (or an automatic control device) through a sufficient angle.

When this alignment has been precisely carried out (as in FIG. 1b), it is possible for the upstream flow 3 of air to enter the annular duct 8 via the perforations 10, 15, in particular if the central duct 5 is further blocked.

Conversely, there must be one or more possible angular positions for the ring 12 in which there is no overlap between the perforations 10 of the common wall 4 and 15 of the ring 12 (as in FIG. 1a). Under these conditions, the perforations 10 of the common wall 4 are blocked and the whole of the upstream flow 3 of air moves into the central duct 5.

To this end, the rotation of the ring 12 also controls the movement of a series of flaps 16 (central flap), 17, 18 (front flaps).

The central flap 16 is arranged inside the central duct 5 and can rotate about an axis 19 which, in the example illustrated, is located substantially on the longitudinal axis of the air vent and is perpendicular thereto. The axis 19 is also located downstream of the perforations 10 of the common wall 4. When the ring 12 is in the position thereof which controls only the restoration of a flow 6 of directional air (FIG. 1a), the central flap 16 is in a position which is substantially aligned on the longitudinal axis of the air vent and does not therefore impair the discharge of the flow 6 of directional air. Conversely, when the ring 12 is in the position thereof which controls only the restoration of a flow 9 of diffusion air (FIG. 1b), the central flap 16 is in a position which is practically perpendicular relative to the longitudinal axis of the air vent and comes into abutment against an annular protuberance 20 which is arranged on the common wall 4. In this manner, it substantially blocks the central duct 5 downstream of the perforations 10 and, since the series of perforations 10, 15 are in alignment with each other, the entire flow 3 of upstream air passes through them in order to enter the annular duct 8 and leave via the perforations 14.

The front flaps 17, 18 which are located at the downstream end of the central duct 5 are supported by a ring 21. They can, in the same manner, rotate about axes which are substantially perpendicular relative to the longitudinal axis of the air vent. When they are in a maximum open position (FIG. 1a), they do not impede the discharge of the flow 6 of directional air and contribute to the orientation thereof. When they are in a closed position (FIG. 1b), they contribute to blocking the central duct 5, for example, by each coming into abutment, on the one hand, against the periphery of the central duct 5 and/or on the other hand against a side of the other front flap 17, 18 (example illustrated in FIG. 1b).

Preferably, the ring 12 and the flaps 16, 17, 18 can, at the request of the user, assume one or more intermediate positions, which may or may not be preadjusted, or can even move in a continuously progressive manner, between the two extreme positions which have been described and illustrated. It is thus possible to finely adjust to a lesser or greater extent the respective proportions of downstream directional air 6 and downstream diffusion air 9. These intermediate positions could be preadjusted using, for example, a notched arrangement which is provided on the periphery of the ring 12.

It must be noted that it is not essential in the context of the invention to provide both a central flap 16 and front flaps 17, 18, the significant factor being that there is at least one flap (or any functionally equivalent device) which can, at the request of the user, substantially completely block the central duct 5 by means of rotation of the ring 12. A single flap similar to the flap 16 but located in the front portion of the air vent could, for example, be used in particular if the precise orientation of the downstream flow 6 of directional air were provided by other independent means.

A second example of an air vent according to the invention is illustrated in FIG. 2. The elements in common with the example of FIG. 1 have the same reference numerals.

In this example, it is the ring 12 itself which constitutes the wall which is common to the two ducts 5, 8. Furthermore, it comprises, on the face thereof directed towards the outer wall 11 of the air vent, one or more helical ribs 22 which are inserted in one or more corresponding housings 23 which are provided on a component which is fixedly joined to the outer wall 11. In this manner, a rotation applied to the ring 12, depending on the direction thereof, allows it to be advanced in the direction of the passenger space 7 or allows it to be caused to retract in the direction of the dashboard 1. Any other equivalent means which allows translation of the ring 12 simultaneously with the rotation thereof would also be able to be used.

The front portion of the ring 12 comprises, over the entire periphery thereof, a lip 24 which, when the ring 12 is in a position of maximum retraction (as in FIG. 2a), comes into contact with the outer face of the dashboard 1. In this position, the lip 24 therefore completely blocks the annular duct 8. Since the flaps 16, 17, 18 are simultaneously in their respective positions of maximum opening, the entire upstream flow 3 of air is converted into a downstream flow 6 of directional air on leaving the central duct 5. In order to block the annular duct 8, it is possible, in addition to or in place of the lip 24, to make provision for the rear end 25 of the ring 12 to come into contact with the outer wall 11 of the air vent in this position.

Conversely, when the ring 12 is in an advanced position (as in FIG. 2b), the lip 24 is located with spacing from the dashboard 1 and therefore provides an annular opening 26. Since the rear end 25 of the ring 12 is also remote from the outer wall 11, it is possible for the upstream flow 3 of air to be introduced into the annular duct 8 and leave via the opening 26. In parallel, the flaps 16, 17, 18 are all in a closed position (the supports 20 on which the central flap 16 is supported are provided in this instance on the ring 12), thus blocking the central duct 5. It is therefore the entire upstream flow 3 of air which is converted into a downstream flow 9 of diffusion air.

Again in this instance, one or more of the intermediate positions between those described and illustrated may preferably be able to be selected by the user.

In a variant, it would be possible to imagine other configurations for the ring 12, the most significant factor being, in this method of implementing the invention, that the movement from one operating mode to another is carried out by means of combined translation and rotation of the ring 12.

Since the rotation axis of the ring 12 can be aligned with the longitudinal axis of the air vent, the installation of the air vent in the dashboard 1 does not present specific problems.

In the example which has been described and illustrated, the annular duct 8 extends over the entire periphery of the central duct 5 but this feature is not obligatory: the annular duct 8 may extend only over a portion of this periphery.

The example of an air vent according to the invention illustrated in FIG. 3 has this feature. It is comparable, in terms of its general design, to that of FIG. 1 in that the ring 12 is inserted around the common wall 4 of the two ducts, central duct 5 and annular duct 8, and carries out, during the movements thereof, a pure rotation, with no translation. It is distinguished by the following points:
the annular duct 8 extends over only a portion (for example, as illustrated, the upper half) of the periphery of the air vent: it can be seen in FIG. 3 that, in the lower portion of the air vent, the ring 12 is enclosed between the common wall 4 and the outer wall 11 with a simple functional clearance which allows it to rotate;
the downstream flow 9 of diffusion air can be discharged from the annular duct 8 via a single perforation 27 which extends over the periphery of the annular duct 8 (or a plurality of perforations of this type which are distributed over the periphery of the annular duct 8); this is no longer provided on the ring 12 but instead on the outer wall 11; the downstream flow of diffusion air is directed into the passenger space 7 via a mouthpiece 28 which is fixed to or integrated in the outer wall 11 and which can be encased in the dashboard 1; it would also be conceivable for these features (perforation(s) 27 provided in the outer wall 11 and the mouthpiece 28 deflecting the downstream flow 9 of diffusion air in the passenger space 7) to be adapted accordingly if the annular duct 8 extends over the entire periphery of the air vent.

In the examples illustrated, the central flap 16 and the front flaps 17, 18 can be activated in a synchronised manner using connection rods so that an action on one of the flaps 16, 17, 18 has an effect on the others. Preferably, a connection having spherical connection rods also allows the ring 21 which supports the front flaps 17, 18 to be rotated about the longitudinal axis of the air vent independently of the central flap 16 in order to direct the downstream flow 6 of directional air in the manner desired by the user.

The rotation of the central flap 16 about the axis 19 when the control ring 12 is activated can be carried out using a rack and pinion system which moves one relative to the other when the control ring 12 is activated. For example, when the central flap 16 is arranged on the control ring 12, the axis 19 comprises a pinion which is fixedly joined to the central flap 16 and the rack is carried by a fixed portion of the air vent. If the central flap 6 is arranged on a fixed portion of the air vent, the rack is mounted on the control ring. The shape of the rack is suitable for pure rotation (as in FIG. 1) or helical rotation (as in FIG. 2) of the control ring 12.

These examples of configurations of means for controlling the movements of the flaps 16, 17, 18 are known per se.

1-11. (canceled)

12. Ventilation system air vent for the passenger space (7) of a motor vehicle, which constitutes the terminal portion of a main air duct which conveys an upstream flow (3) of air, the air vent being provided with diffusion means for converting the upstream flow (3) of air into a downstream flow (9) of diffusion air, directional means for converting the upstream flow of air into a downstream flow (6) of directional air and control means for switching from one downstream air flow mode to the other by means of connecting one or other of the diffusion means and directional means to the main air duct, characterised in that it comprises a central duct (5) which is at least partially coaxial relative to an annular duct (8), the two ducts (5, 8) having their upstream ends (2) connected to the main air duct and each having, at the downstream end thereof, one of the diffusion means and directional means, and a control ring (12) being able to be placed between a first position in which it serves to close a connection between the central duct (5) and the annular duct (8) and a second position in which the ring (12) serves to open this connection.

13. Air vent according to claim 12, characterised in that it also comprises means for blocking the central duct (5), which means are controlled by the movement of the ring (12).

14. Air vent according to claim 13, characterised in that the means for blocking the central duct (5) are constituted by at least one flap (16, 17, 18).

15. Air vent according to claim 12, characterised in that a common cylindrical wall (4) separates the central duct (5) and the annular duct (8), in that the common wall (4) is provided with perforations (10) along one of the circumferences thereof, and in that the ring (12) is inserted around the common wall (4) and carries perforations (15) which can, by rotating the ring (12) to at least one angular position, move into alignment with the perforations (10) of the common wall (4), the ring (12) also being able, by rotating to at least another angular position, to block the perforations (10) of the common wall (4).

16. Air vent according to claim 15, characterised in that the diffusion means comprise one or more perforations (14) which are provided, at the end of the annular duct (8), in the front portion (13) of the ring (12) which is intended to protrude into the passenger space (7) of the vehicle when the air vent is mounted in the dashboard (1).

17. Air vent according to claim 12, characterised in that the ring (12) constitutes a common cylindrical wall which separates the central duct (5) and the annular duct (8), in that it comprises means which allow translation of the ring (12) along the longitudinal axis thereof simultaneously with the rotation thereof in order to move the ring (12) from a position for blocking the annular duct (8) to a position for blocking the central duct (5).

18. Air vent according to claim 17, characterised in that the front portion of the ring (12) comprises, on the periphery thereof, a lip (24) which, when the ring (12) is in a position of maximum retraction, is intended to come into contact with the outer face of the dashboard (1) in order to block the annular duct (8), in that when the ring (12) is in an advanced position, the rear end (25) thereof is remote from the outer wall (11) of the air vent in order to allow the passage of at least a portion of the flow (3) of upstream air in the annular duct (8) in order to constitute the flow (9) of diffusion air, and in that, in this same advanced position, the lip (24) is intended to be remote from the dashboard (1) in order to define an annular opening (26) through which the flow (9) of diffusion air can be introduced into the passenger space (7).

19. Air vent according to claim 17, characterised in that the means which allow a translation of the ring (12) simultaneously with the rotation thereof comprise one or more helical ribs (22) which are inserted in one or more corresponding housings (23) provided on a component which is fixedly joined to the outer wall (11) of the air vent.

20. Air vent according to claim 18, characterised in that the means which allow a translation of the ring (12) simultaneously with the rotation thereof comprise one or more helical ribs (22) which are inserted in one or more corresponding housings (23) provided on a component which is fixedly joined to the outer wall (11) of the air vent.

21. Air vent according to claim 15, characterised in that the diffusion means comprise at least one perforation (27) which is provided on at least a portion of the outer wall (11) of the air vent and via which the downstream flow (9) of diffusion air is introduced into the passenger space (7).

22. Air vent according to claim 21, characterised in that it comprises a mouthpiece (28) which directs in the passenger space (7) the downstream flow (9) of diffusion air which is discharged from the perforation (27).

23. Air vent according to any claim 12, characterised in that the ring (12) may be retained in at least one intermediate position between the first and second positions, in order to simultaneously allow the passage of a downstream flow (9) of diffusion air and a downstream flow (6) of directional air in the passenger space (7).
